(19) United States
(12) Patent Application Publication
(10) Pub. No.: US 2026/0348284 A1
(43) Pub. Date: Nov. 5, 2026

(54) COATING MATERIAL FOR WATER EROSION RESISTANCE OF STEAM TURBINE BLADES AND LASER CLADDING PROCESS FOR THE SAME

(71) Applicant: HAINAN NUCLEAR POWER CO., LTD, Hainan (CN)

(72) Inventors: Xiang XUE, Hainan (CN); Zhigang WEI, Hainan (CN); Yong LI, Hainan (CN); Fuguang LIU, Hainan (CN); Tengxiao YUE, Hainan (CN); Bo ZHAO, Hainan (CN); Xiaoliang WU, Hainan (CN); Weiwei XIE, Hainan (CN); Xiaoen WANG, Hainan (CN); Zhiqiang LI, Hainan (CN); Yufu LU, Hainan (CN); Shuyu WU, Hainan (CN)

(21) Appl. No.: 18/996,992

(22) PCT Filed: Jun. 28, 2024
(86) PCT No.: PCT/CN2024/102362

§ 371 Date: Jan. 18, 2025

(30) Foreign Application Priority Data
Oct. 27, 2023 (CN) 202311405555.X

(51) Int. Cl. F01D 5/28; C22C 38/02; C22C 38/04; C22C 38/06; C22C 38/22; C22C 38/24; C22C 38/26; C23C 24/10

(52) U.S. Cl. CPC F01D 5/288; C22C 38/02; C22C 38/04; C22C 38/06; C22C 38/22; C22C 38/24; C22C 38/26; C23C 24/106; F05D 2300/171; F05D 2300/611

(57) ABSTRACT

The present invention provides a coating material for water erosion resistance of steam turbine blades and a laser cladding process for the coating material. The coating material for water erosion resistance of steam turbine blades has a composition of: C: 0.65-0.80 wt %, Cr: 3.00-6.50 wt %, Mn: 0.22-0.55 wt %, Nb: 0.30-0.80 wt %, Mo: 4.00-8.50 wt %, Si: 0.1-0.3 wt %, W: 5.00-8.00 wt %, V: 1.50-2.50 wt %, and Al: 0.40-0.60 wt %, with a balance being Fe and a small amount of impurity elements. The cladding process has a laser power density of 100-150 W/mm², uses argon gas to protect the melt pool, and has a powder feeding rate of 40-60 r/min and a multi-channel overlap ratio of 30-50%. The coating material provided by the present invention has the characteristics of high toughness, low possibility of producing pores, and excellent water erosion resistance. The cladding layer prepared from this coating material has high water erosion resistance and good comprehensive mechanical properties.

### TECHNICAL FIELD

The present invention relates to the field of coating protection technology for water erosion of steam turbine blades, particularly to a coating material for water erosion resistance of steam turbine blades and a laser cladding process for the coating material.

### BACKGROUND ART

With development of steam turbines for power plant in China towards large capacity and high parameters, safety and reliability of blades have become particularly important. Water erosion of blades has a significant impact on thermal efficiency and safety reliability of steam turbine operation. Water erosion of turbine blades refers to the phenomenon of damage and peeling of material on the blade surface due to high-speed collision between the blades in the wet-steam region and secondary water droplets carried in steam flow. It is generally considered that the water erosion damage is formed by a process including: water film from the surface of a static vane to the outlet edge is broken by steam flow, and forms water droplets of tens to hundreds of micrometers in diameter. When such water droplets collide with the surface of the blade, it changes from a spherical shape to a film shape, generating high pressure inside the contact area between the water droplet and the blade. When the stress exceeds the yield limit of the material, the blade material undergoes local plastic deformation and strain hardening. Under the repeated action of this pressure, the blade begins to produce fatigue cracks when the fatigue limit of the material is reached. When water droplets collide the interior of such cracks, the pressure inside the droplets will cause the cracks to develop deeper, causing the blade material to detach from the blade surface and form water erosion.

Generally, regarding a blade in low-pressure last stage of a steam turbine, the water erosion occurs on the inlet side of the blade tip, and may occur on the outlet side of the blade tip or even at the root of the blade for a few blades. Water erosion damage may lead to a honeycomb-like morphology on the surface of blade, with gradually serrated edges. Further expansion of the water erosion may result in the formation of notches in this region. Water erosion of steam turbine blades is a common phenomenon, especially for modern high-power steam turbines with last stage blades longer than 1 m, which has a blade tip linear speed of up to 500-600 m/s, resulting in a relative collision speed between water droplets and blades of 300 m/s or more. Even with protective measures such as brazing hard alloys, water erosion of blade exists widely, especially after the unit operated deviating from the design conditions, the water erosion problem will further intensify, causing a decrease in the flow efficiency of the turbine blade cascade, weakening the strength of the blade substrate, and generating crack sources, and thus changing the vibration characteristics of blades, which may easily cause blade vibration, cracking and fracture.

For the water erosion of steam turbine blades, various surface protection methods are usually used for the treatment of water erosion, such as brazing Stellite alloy sheets, thermal spraying, welding and other traditional methods. In recent years, laser cladding has become a new surface protection method for steam turbine blades against water erosion due to its advantages of low heat input, small heat affected zone, and high metallurgical bonding strength. However, according to a lot of experiments conducted by the inventor and disclosed data in literatures, conventional coating materials for water erosion resistance, such as Stellite alloy powder, H13 steel powder and cermet powder materials containing WC particles, cannot surpass the water erosion resistance of Stellite alloy bulk materials, even if laser cladding is used for coating preparation. With the booming development of power market in China, more and more steam turbines are participating deeply in peak shaving, and water erosion has become an increasingly serious problem. It is necessary to develop a new coating material that can form a cladding coating which will has a better water erosion resistance than the Stellite alloy bulk materials.

### SUMMARY

The present invention aims to provide a coating material for water erosion resistance of steam turbine blades and a laser cladding process for the coating material, which solves the problem of low water erosion resistance of existing coating materials for surface engineering.

In order to achieve the above objective, the present invention provides the following technical solutions:

A coating material for water erosion resistance of steam turbine blades, comprises components of: C: 0.65-0.80 wt %, Cr: 3.00-6.50 wt %, Mn: 0.22-0.55 wt %, Nb: 0.30-0.80 wt %, Mo: 4.00-8.50 wt %, Si: 0.1-0.3 wt %, W: 5.00-8.00 wt %, V: 1.50-2.50 wt %, and Al: 0.40-0.60 wt %, with a balance being Fe and a small amount of impurity elements.

Further, the impurity elements comprise S≤0.02 wt % and P≤0.008 wt %.

Further, the coating material has a particle size of 15-53 μm.

Further, the coating material comprises components of: C: 0.70 wt %, Cr: 6.50 wt %, Mn: 0.45 wt %, Nb: 0.34 wt %, Mo: 6.50 wt %, Si: 0.20 wt %, W: 7.00 wt %, V: 2.00 wt %, Al: 0.50 wt %, S≤0.02 wt %, and P≤0.008 wt %, with a balance being Fe element.

Further, the coating material comprises components of: C: 0.70 wt %, Cr: 6.50 wt %, Mn: 0.45 wt %, Nb: 0.50 wt %, Mo: 6.50 wt %, Si: 0.30 wt %, W: 7.00 wt %, V: 2.00 wt %, Al: 0.60 wt %, S≤0.02 wt %, and P≤0.008 wt %, with a balance being Fe element.

Further, the coating material comprises components of: C: 0.70 wt %, Cr: 5.00 wt %, Mn: 0.45 wt %, Nb: 0.50 wt %, Mo: 4.00 wt %, Si: 0.30 wt %, W: 7.00 wt %, V: 1.50 wt %, Al: 0.60 wt %, S≤0.02 wt %, and P≤0.008 wt %, with a balance being Fe element.

A laser cladding process for a coating material for water erosion resistance of steam turbine blades, has a laser power density of 100-150 W/mm², uses argon gas to protect a melt pool, and has a powder feeding rate of 40-60 r/min and a multi-channel overlap ratio of 30-50%.

Compared with the prior art, the coating material for water erosion resistance of steam turbine blades and the laser cladding process for the coating material provided by the present invention have the following beneficial effects:

The coating material provided by the present invention has characteristics of high toughness, low possibility of producing pores, and excellent water erosion resistance. The cladding layer prepared from this coating material has high water erosion resistance and good comprehensive mechanical properties.

The present invention can form a metallurgical bonding interface between cladded coating and blade surface, which has a high bonding strength and will not detach.

Under appropriate heat input, laser cladding coatings are less prone to produce pores and cracks.

The material is iron-based, and has a price more economical compared to other materials such as cobalt-based, nickel-based and titanium alloys.

In the application process, when combined with other fixtures, it is easy to achieve automation and has good process stability.

### DETAILED DESCRIPTIONS

The present invention is further illustrated below with reference to specific embodiments.

The present invention provides a coating material for water erosion resistance of steam turbine blades, having a chemical composition of: C: 0.65-0.80 wt %, Cr: 3.00-6.50 wt %, Mn: 0.22-0.55 wt %, Nb: 0.30-0.80 wt %, Mo: 4.00-8.50 wt %, Si: 0.1-0.3 wt %, W: 5.00-8.00 wt %, V: 1.50-2.50 wt %, and Al: 0.40-0.60 wt %, with a balance being Fe and a small amount of impurity elements, wherein the impurity elements comprise S≤0.02 wt % and P≤0.008 wt %.

The design concepts of the alloy powder composition of the present invention are as follows:

the working temperature of the region where water erosion occurs on the steam turbine blades is low, which is below 100 °C; Fe element with good laser cladding process performance is used as a matrix to reduce the cost, and carbide forming elements such as Cr and W are added to improve hardness of the coating after cladding; at the same time, Cr may increase hardenability, making the material have higher hardness and corrosion resistance after rapid laser cooling, Al element is added as a dispersed oxide generating element, and due to the low Gibbs free energy required for Al oxidation, it preferentially reacts with oxygen in the melt pool, thereby reducing the oxygen content in other elements and lowering the porosity in the coating; Si is also added for the functions of deoxidation and slagging, which helps to reduce the porosity in the coating; Grain refinement elements, such as V, Mo, and Nb, are added to improve the toughness of the cladding coating and reduce the tendency of cracking in the coating; meanwhile, and the content of V is reduced to prevent the formation of severe slag inclusions or pores in the coating.

C is mainly to form alloy carbides with a large amount of carbide elements such as W, Cr, V, and Nb. During the high-temperature stage of laser cladding, a portion of carbides dissolve in austenite, ensuring the hardness of martensite, while another portion of undissolved carbides plays a role in refining grain size and wear resistance. C is controlled at a content of 0.65-0.80 wt %.

W is a strong carbide forming element, and tungsten carbides are difficult to dissolve in austenite during laser cladding. Undissolved carbides may prevent grain growth and improve the wear resistance of the steel. W is controlled at a content of 5.00-8.00 wt %.

Mo and W are similar elements, and molybdenum can partially replace tungsten in this material. Molybdenum is also one of the important elements for improving hardness. Molybdenum may reduce the eutectic reaction temperature during pool crystallization, refine the as cast structure, reduce the unevenness of carbides, and improve the plasticity and toughness of the cladding layer. Mo is controlled at a content of 4.00-8.50 wt %.

Mn has good effects in deoxidation and desulfurization, and thus eliminating or reducing the harm of S in the steel. Mn is controlled at a content of 0.22-0.55 wt %.

Cr is also a carbide forming element that reduces the martensitic transformation temperature, increases hardenability, and makes the material have higher hardness after rapid laser cooling. Cr is controlled at a content of 3.00-6.50 wt %.

V is a stronger carbide forming element, which forms stable carbides with high hardness. The VC formed after cladding has better wear resistance than M₂C and M₆C, and V increases the wear resistance of the coating after cladding. At the same time, vanadium has the effect of refining the grain of as cast structure. V is controlled at a content of 1.50-2.50 wt %.

Al is a non-carbide forming element, but it is a deoxidizing material that can improve the porosity and oxidation tendency in coatings, which increases the hardness. A high content of aluminum is not suitable, and Al should be controlled at a content of 0.40-0.60 wt %.

Si is solid dissolved in the matrix and has the effect of improving hardness. Silicon may also eliminate harmful rod-shaped molybdenum or tungsten carbides, thereby improving the performance of the material. However, a high content of Si may significantly reduce plasticity and toughness, and Si is controlled at a content of 0.1-0.3 wt %.

Nb forms stable carbides in high-speed steel. Adding an appropriate amount of niobium may improve wear resistance of steel, reduce overheating sensitivity of steel and refine grain sizes, thereby improving toughness. If the amount of niobium is excessive, it is easy to form large niobium containing carbides, and niobium is controlled at a content of 0.30-0.80 wt %.

By adding elements such as Cr, Mn, Nb, Mo, Si, W, V, and Al to the low-cost iron-based material, the laser cladding process performance of the material is greatly improved. The coating has a dense structure without pores. The coating has fine grain size, high toughness, high hardness, and excellent water erosion resistance. According to tests by the inventor, the water erosion resistance ability is significantly improved compared to Stellite alloy bulk materials, and it is suitable for protecting steam turbine rotor blades from water erosion damages.

The coating material for water erosion resistance of steam turbine blades provided by the present invention is a powder material with a particle size of 15 μm to 250 μm.

In addition, the present invention provides a laser cladding process for the coating materials for water erosion resistance of steam turbine blades. The main parameters controlled in the present invention are the chemical composition of the coating and the heat input control during the laser cladding process. To reduce the porosity in the cladding layer, it is necessary to lower the heat input during the laser cladding process. The cladding process has a laser power density of 100-150 W/mm², uses argon gas to protect the melt pool, and has a powder feeding rate of 40-60 r/min and a multi-channel overlap ratio of 30-50%. In addition to laser cladding, the above-mentioned materials can also be coated using plasma cladding technology.

### EXAMPLE 1

A coating material for water erosion resistance of steam turbine blades, with a material composition of C: 0.70 wt %, Cr: 6.50 wt %, Mn: 0.45 wt %, Nb: 0.34 wt %, Mo: 6.50 wt %, Si: 0.20 wt %, W: 7.00 wt %, V: 2.00 wt %, Al: 0.50 wt %, S≤0.02 wt %, and P≤0.008 wt %, with a balance being Fe element. The coating material for water erosion resistance of steam turbine blades is made into spherical powder with a particle size of 15-53 pm by atomization process. High speed laser cladding is used with a power density of 100 W/mm 2 for laser cladding.

### EXAMPLE 2

A coating material for water erosion resistance of steam turbine blades, with a material composition of C: 0.70 wt %, Cr: 6.50 wt %, Mn: 0.45 wt %, Nb: 0.50 wt %, Mo: 6.50 wt %, Si: 0.30 wt %, W: 7.00 wt %, V: 2.00 wt %, Al: 0.60 wt %, S≤0.02 wt %, and P≤0.008 wt %, with a balance being Fe element. The powder is made into spherical powder with a powder particle size of 15-53 μm by atomization process. High speed laser cladding is used with a power density of 100 W/mm² for laser cladding.

### EXAMPLE 3

A coating material for water erosion resistance of steam turbine blades, with a material composition of C: 0.70 wt %, Cr: 5.00 wt %, Mn: 0.45 wt %, Nb: 0.50 wt %, Mo: 4.00 wt %, Si: 0.30 wt %, W: 7.00 wt %, V: 1.50 wt %, Al: 0.60 wt %, S≤0.02 wt %, and P≤0.008 wt %, with a balance being Fe element. The powder is made into spherical powder with a powder particle size of 100-250 μm by atomization process. Conventional laser cladding is used with a power density of 150 W/mm² for laser cladding.

Therefore, the material of the present invention is an alloy material with excellent water erosion resistance. By optimizing the proportion of each component in the alloy and strictly controlling the power density during the laser cladding process, a coating material can be prepared with low production cost, high hardness, good toughness, low cracking, dense and pore-free coating, and excellent water erosion resistance.

The above descriptions are only specific embodiments of the present invention, but the protection scope of the present invention is not limited thereto. Any modifications or substitutions that can be easily thought of by a person skilled in the art within the technical scope disclosed in the present invention should be included in the protection scope of the present invention. Therefore, the protection scope of the present invention should be based on the protection scope of the appended claims.

1. A coating material for water erosion resistance of steam turbine blades, characterized in having a composition of: C: 0.65-0.80 wt %, Cr: 3.00-6.50 wt %, Mn: 0.22-0.55 wt %, Nb: 0.30-0.80 wt %, Mo: 4.00-8.50 wt %, Si: 0.1-0.3 wt %, W: 5.00-8.00 wt %, V: 1.50-2.50 wt %, and Al: 0.40-0.60 wt %, with a balance being Fe and a small amount of impurity elements.

2. The coating material for water erosion resistance of steam turbine blades according to claim 1, characterized in that, in the impurity elements, S≤0.02 wt % and P≤0.008 wt %.

3. The coating material for water erosion resistance of steam turbine blades according to claim 1, characterized in that the coating material has a particle size of 15-53 μm.

4. The coating material for water erosion resistance of steam turbine blades according to claim 1, characterized in that the coating material has a composition of: C: 0.70 wt %, Cr: 6.50 wt %, Mn: 0.45 wt %, Nb: 0.34 wt %, Mo: 6.50 wt %, Si: 0.20 wt %, W: 7.00 wt %, V: 2.00 wt %, Al: 0.50 wt %, S≤0.02 wt %, and P≤0.008 wt %, with a balance being Fe element.

5. The coating material for water erosion resistance of steam turbine blades according to claim 1, characterized in that the coating material has a composition of: C: 0.70 wt %, Cr: 6.50 wt %, Mn: 0.45 wt %, Nb: 0.50 wt %, Mo: 6.50 wt %, Si: 0.30 wt %, W: 7.00 wt %, V: 2.00 wt %, Al: 0.60 wt %, S≤0.02 wt %, and P≤0.008 wt %, with a balance being Fe element.

6. The coating material for water erosion resistance of steam turbine blades according to claim 1, characterized in that the coating material has a composition of: C: 0.70 wt %, Cr: 5.00 wt %, Mn: 0.45 wt %, Nb: 0.50 wt %, Mo: 4.00 wt %, Si: 0.30 wt %, W: 7.00 wt %, V: 1.50 wt %, Al: 0.60 wt %, S≤0.02 wt %, and P≤0.008 wt %, with a balance being Fe element.

7. A laser cladding process for a coating material for water erosion resistance of steam turbine blades, characterized in that the cladding process has a laser power density of 100-150 W/mm², uses argon gas to protect a melt pool, and has a powder feeding rate of 40-60 r/min and a multi-channel overlap ratio of 30-50%.
